(19) United States
(12) Patent Application Publication
(10) Pub. No.: US 2024/0190450 A1
(43) Pub. Date: Jun. 13, 2024

(54) METHOD FOR EMERGENCY STEERING AND EMERGENCY STEERING SYSTEM

(71) Applicant: National Electric Vehicle Sweden AB, TROLLHÄTTAN (SE)

(72) Inventors: Johan Hägnander, TROLLHÄTTAN (SE); Ashrith Adisesh, TROLLHÄTTAN (SE); Ansh Gandhi, TROLLHÄTTAN (SE); Elham Goudarzi, TROLLHÄTTAN (SE); Utsav Khan, TROLLHÄTTAN (SE); Torbjörn Norlander, TROLLHÄTTAN (SE)

(21) Appl. No.: 18/286,926

(22) PCT Filed: Apr. 14, 2022
(86) PCT No.: PCT/EP2022/059980

§ 371 Date: Oct. 13, 2023

(30) Foreign Application Priority Data
Apr. 15, 2021 (SE) 2150470-9

(51) Int. Cl. B60W 50/029; B60W 10/04; B60W 10/18; B60W 30/095; B62D 9/00

(52) U.S. Cl. CPC B60W 50/029; B60W 10/04; B60W 10/18; B60W 30/0956; B62D 9/002; B62D 9/005; B60W 2520/06; B60W 2554/4041; B60W 2554/802

(57) ABSTRACT

The present disclosure relates to a method for emergency steering of a vehicle in response to a failure of a vehicle steering system, comprising determining a failure of the vehicle steering system, locking a first and a second wheel of a steering axle of said vehicle, such that said first and second wheels of said steering axle of said vehicle are prevented from rotating, and applying a first drive torque to a first wheel and a second different torque to a second wheel, of a non-steering axle of said vehicle, thereby steering the vehicle into a desired direction. The present disclosure further relates to an emergency steering system of a vehicle for steering the vehicle in response to a failure of a vehicle steering system, as well as to a vehicle comprising such a system, and to a computer program for performing the steps of the method.

### TECHNICAL FIELD

The present disclosure relates to a method and system for emergency steering of a vehicle.

### BACKGROUND

The safety of vehicles is one of the most important concerns of the automotive industry. Technological advances in the areas of passive safety and active safety have contributed to reduce injury and death rates. In particular, various Advanced driver-assistance systems (ADAS) have improved road safety by using sensors and automated technology to allow the vehicle to respond to unfavorable conditions and even minimize the effect of driver errors. Electronic Stability Control (ESC), Traction Control System (TSC), Anti-lock Braking System (ABS) are examples of systems that improve handling of the vehicle. Advanced Emergency Braking Systems (AEBS) are adapted to autonomously brake and/or steer the vehicle to avoid a collision, without driver input. AEBS commonly works only up to limited speeds (50 km/h) and requires fully functioning sensors and actuators of e.g. the steering and braking systems.

The steering system of a vehicle is itself a safety critical system. Since no component is immune to failure, redundancy would be desirable. However, providing the vehicle with a fully redundant steering system is unrealistic both in terms of costs and increased weight. In the event of a failure of the steering system, a common solution is to bring the vehicle to a halt by braking. However, in the absence of redundancy, once the ability to control the steering of a steering axle has been lost, controlling the trajectory of the vehicle is not possible. In some situations, avoiding a potential collision may not be possible by relying only on emergency braking.

### SUMMARY

It is an object of the present disclosure to alleviate at least some of the drawbacks and to provide an effective method for emergency steering, as well as a system for implementing the same.

The invention is defined by the appended independent claims, with embodiments being set forth in the appended dependent claims, in the following description, and in the drawings.

According to a first aspect of the inventive concept, there is provided a method for emergency steering of a vehicle in response to a failure of a vehicle steering system, the method comprising the steps of:
determining, by a steering system failure determining unit, a failure of the vehicle steering system,
locking a first and a second wheel of a steering axle of said vehicle, such that said first and second wheels of said steering axle are prevented from rotating, and
applying, a first drive torque to a first wheel of a non-steering axle of said vehicle and a second different torque to a second wheel of a non-steering axle of said vehicle, thereby steering the vehicle into a desired trajectory.

In the context of this application, the term “axle” refers to a transverse pair of wheels or wheel assemblies, and by extension to a line drawn between the centers of rotation of the wheels of the axle. Each wheel or wheel assembly of an axle is located on opposite sides of the vehicle. The line drawn between the centers of rotation of the respective wheels is substantially perpendicular to a longitudinal extension of the vehicle. The respective wheels of an axle need not be physically connected by an axle shaft. A steering axle is an axle in which the angular position of the wheels in relation to the axle can be changed. A non-steering axle is an axle in which the angular position of the wheels is fixed in relation to the axle.

The present disclosure is at least partly based on the realization that the safety of the vehicle can be improved by reducing the reliance on a steering axle for inducing a change of trajectory of the vehicle. In the event of a failure of one or several components of the steering system leading to an inability to control the angular position of one or several wheels of the steering axle, the method provides at least some ability to steer the vehicle into a desired trajectory using only a non-steering axle. The lateral movement provided may allow the vehicle to avoid a dangerous situation.

In one embodiment, the first torque and the second torque are of the same magnitude but with opposite rotational directions, i.e. the first torque is a drive torque and the second torque is a brake torque of equal magnitude, or vice versa. The resulting yaw moment induces the vehicle to rotate about its yaw axis. The same resulting yaw moment may alternatively be achieved by an infinite number of combinations of first and second torques. For example, the first torque may be a drive torque of a first magnitude, and the second torque may be a drive torque of a second magnitude, wherein the first magnitude is larger than the second magnitude, or vice versa.

Locking a first and a second wheel of the steering axle such that the wheels are prevented from rotating can improve the control of the lateral movement. If the wheels are allowed to rotate, depending on the angular position of the wheels following the failure of the steering system, the grip of the tires on the road may lead the vehicle towards a different trajectory than the desired trajectory. This could counteract the effect of applying different torques on the wheels of the non-steering axle. If, on the other hand, the wheels of the steering axle are locked, they will experience sliding friction, which may be easier to overcome in order to steer the vehicle into the desired trajectory.

Locking the wheels of the steering axle may comprise applying a maximum braking torque on the wheels.

The desired trajectory may be autonomously determined by the vehicle, e.g. based on input sensors like cameras or radar. Alternatively, the desired trajectory may be based on input from a driver, such as an angle of a steering wheel. The torques to be applied on the respective wheels of the non-steering axle may be autonomously determined by the vehicle, based on the desired trajectory.

According to an embodiment, the method further comprises:
detecting an object in an environment of said vehicle, and
determining the first torque and second torque needed to steer said vehicle into said desired trajectory for avoiding a collision between said vehicle and said object.

This provides an additional level of safety. A collision with the object can be avoided even in situations where an emergency brake could not stop the vehicle in time. The object may be a stationary object or a moving object. The steps of detecting an object and determining the first torque and second torque may be performed continuously, or at an appropriate frequency, such that the new first torque and second torque are determined and the steering updated with every iteration.

The object may be detected by an object detection unit based on data provided by at least one of a radar, a lidar, a camera, or any combination thereof.

Alternatively, the method further comprises:
detecting a traffic marker in an environment of said vehicle, and
determining the first torque and second torque needed to steer said vehicle into said desired trajectory for avoiding crossing path with said traffic marker.

The traffic marker may e.g. be a marker delimiting a lane of a road. As such, the method may serve to keep the vehicle in the traffic lane in which the vehicle is currently travelling.

According to an embodiment, a plurality of objects may be detected in the environment of the vehicle. A priority ranking may be established in order to determine which object or objects is/are the most critical to avoid.

According to an embodiment, the method further comprises:
determining a distance and a relative bearing of said object in relation to said vehicle,
determining a current trajectory of said vehicle,
determining if said object is in a travel path of said vehicle based on said distance and relative bearing of said object and said current trajectory of said vehicle.

Hereby, the desired trajectory may be based on the current trajectory of the vehicle and the distance and bearing of the object. In some embodiments, the object may be assumed to have a static position. If assumed to have a static position, that position may be determined a plurality of times over a period of time, so as to reconfirm the distance and relative bearing of the object in relation to the vehicle. The method may additionally or alternatively comprise determining a travel path of said object, e.g. with a position and a direction that could include the traveling angle and speed of the object. If the traveling path of the object is determined a future colliding point can be estimated based on the current trajectory, and the desired trajectory may be set so as to avoid such collision. It should thus be understood that determining if said object is in a travel path of said vehicle may comprise determining if said vehicle will collide with said object based on the current trajectory of said vehicle and said travel path of said object. The desired trajectory, i.e. the trajectory needed to avoid a collision between said vehicle and said object may thus change in response to a change of position of the object.

According to an embodiment, said step of determining a failure of the vehicle steering system further comprises:
receiving an input signal indicative of a desired angular position of said first and second wheels of said steering axle in relation to said steering axle,
determining an actual angular position of said first and second wheels of said steering axle in relation to said steering axle,
establishing a difference between said desired angular position and said actual angular position of said first and second wheels of said steering axle in relation to said steering axle.

This allows a failure of the steering system to be rapidly discovered. The desired angular position and the actual angular position of the first and second wheels of the steering axle in relation to said steering axle may be continuously monitored or monitored at an appropriate frequency. A failure of the steering system may be determined when the established difference exceeds a predetermined threshold.

The input signal indicative of a desired angular position of the wheels of the steering axle may be based on sensor data indicative of an angle of the steering wheel. Alternatively, the input signal indicative of a desired angular position of the wheels of the steering axle may be based on a steering command of an autonomous driving system.

According to an embodiment, the step of locking the first and second wheel of the steering axle comprises disabling the anti-lock braking system (ABS) for said first and second wheel of the steering axle.

Disabling the ABS ensures that the braking system does not receive contradictory inputs. The ABS could otherwise counteract the any command of the control unit to lock the wheels, by commanding the braking system to release the respective brakes as soon a locked state of the respective wheels is detected. Hereby, a complete locking of the first and second wheel of the steering axle may be ensured.

According to a second aspect of the inventive concept, there is provided an emergency steering system of a vehicle for steering the vehicle in response to a failure of a vehicle steering system, comprising:
a steering system failure determining unit configured to determine a failure of the vehicle steering system,
a locking member configured to lock a first and second wheel of a steering axle of said vehicle, such that the first and second wheels of said steering axle are prevented from rotating, when a failure of the steering system has been determined, and
a torque applying member configured to apply a first drive torque to a first wheel and a second different torque to a second wheel of a non-steering axle of said vehicle, thereby steering the vehicle into a desired trajectory, wherein the torque applying member comprises a motor.

The system may be suitable to carry out a method for emergency steering of a vehicle as described in connection with the first aspect of the inventive concept. It should be understood that any steps and embodiments of the first aspect may, as far as is compatible with the system, be implemented by the system according to the second aspect of the inventive concept. Any advantages described in connection with the first aspect thus also apply to any system implementing the steps of a method according the first aspect.

The locking member may comprise a brake, such as a frictional brake or an electromagnetic brake. The locking member may additionally or alternatively comprise an engine adapted to apply engine brake torque to one or both of the first and second wheel of the steering axle. The locking member may comprise a regenerative brake, i.e. an electric motor functioning as a generator. The locking member may be configured to lock the first and second wheel of the steering axle by applying a maximum braking torque to said first and second wheel of the steering axle. One common locking member may be configured apply brake torque to both the first and the second wheel of the steering axle. Alternatively, a separate locking member may be configured to apply brake torque to each respective wheel of the steering axle. Preferably, the rotational motion that is locked is the rolling motion of the wheels.

The torque applying member may be configured to apply a drive torque or a brake torque. The torque member may comprise a motor, such as an electric motor. The motor may be configured to apply drive torque or brake torque, e.g. when used as a regenerative brake. The torque applying member may additionally or alternatively comprise a brake, such as a frictional brake or an electromagnetic brake. A separate torque applying member may be configured to apply a torque to each respective wheel of the non-steering axle. The emergency steering system may thus comprise more than one torque applying members. For example, the emergency steering system may comprise at least two torque applying members. According to an embodiment, the emergency steering system further comprises two torque applying members, wherein a first torque applying member is configured to apply a first torque to a first wheel of a non-steering axle of said vehicle and a second torque applying member is configured to apply a second different torque to a second wheel of a non-steering axle of said vehicle.

According to an embodiment, the system further comprises an object detection unit configured to detect an object in an environment of said vehicle, wherein the system is further configured to determine the first torque and second torque needed to steer said vehicle into said desired trajectory for avoiding a collision between said vehicle and said object.

Hereby, the system may take objects on the road into consideration when applying the torques to steer the vehicle in a desired trajectory. Thereby, the vehicle safety will be further increased, both for passengers of the vehicle and for people and property in that might be associated with the object. The object may be another vehicle.

The system may comprise at least one of a radar, a lidar, a camera, or any combination thereof, in communication with the object detection unit. The object detection unit may be configured to detect a plurality of objects in the environment of the vehicle. The system may be configured to establish a ranking in order to determine which object or objects is/are the most critical to avoid.

According to an embodiment, the system is further configured to:
determine a distance and a relative bearing of said object in relation to said vehicle,
determine a current trajectory of said vehicle, and
determine if said object is in a travel path of said vehicle based on said distance and relative bearing of said object and said current trajectory of said vehicle.

The system may comprise an inertial measurement unit configured to determine a heading of the vehicle. The current trajectory may be determined based on said heading and a current speed of the vehicle. Additionally or alternatively, the current trajectory may be determined based on GPS data from a navigation system of the vehicle.

According to an embodiment, the steering system failure determining unit is further configured to:
receive an input signal indicative of a desired angular position of said first and second wheels of said steering axle in relation to said steering axle,
determine an actual angular position of said first and second wheels of said steering axle in relation to said steering axle,
establish a difference between said desired angular position and said actual angular position of said first and second wheels of said steering axle in relation to said steering axle.

The system may comprise at least one steering wheel angle sensor. The input signal indicative of a desired angular position of the first and second wheels of the steering axle in relation to the steering axle may be based on sensor data from the steering wheel angle sensor. Alternatively, the input signal may be based on a steering command from an autonomous driving system. The system may further comprise at least one wheel angle sensor configured to determine an angular position of the first and second wheels of the steering axle.

According to a third aspect of the inventive concept, there is provided a vehicle comprising a system according to the any of the embodiments as described above.

According to a fourth aspect of the inventive concept, there is provided a computer program comprising program code means for performing the steps of a method according to any of the embodiments as described above, when said program is run in an embedded system in a vehicle.

### BRIEF DESCRIPTION OF THE DRAWINGS

The inventive concept, some non-limiting embodiments and further advantages will now be further described with reference to the drawings, in which:

FIG. 1 is a flow chart illustrating a method according to the first aspect of the inventive concept,

FIG. 2 is a schematic illustration of a system according to the second aspect of the inventive concept.

### DETAILED DESCRIPTION OF THE DRAWINGS

Embodiments of the invention will now be described with reference to the accompanying drawings. The invention may, however, be embodied in many different forms and should not be construed as limited to the embodiments set forth herein. Rather, these embodiments are provided so that this disclosure will be thorough and complete and will fully convey the scope of the invention to those skilled in the art. The terminology used in the detailed description of the particular embodiments illustrated in the accompanying drawings is not intended to be limiting of the invention. In the drawings, like numbers refer to like elements.

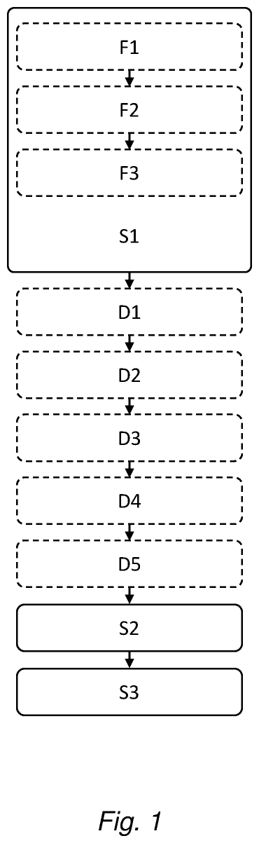

FIG. 1 illustrates one exemplary embodiment of a method for emergency steering of a vehicle in response to a failure of a vehicle steering system according to the present disclosure. The method comprises three major steps, S1-S3, and a number of optional steps, F1-F3 and D1-D5, the optional steps being illustrated with dashed lines.

Step S1 consists of determining a failure of the vehicle steering system. In one alternative, this step comprises the steering failure determining unit receiving an input signal indicative of a desired angular position of the first and second wheels of the steering axle in relation to said steering axle (Step F1). In a conventional vehicle, the input signal is provided by a sensor measuring the angle of the steering wheel. In this case, the desired angular position of the first and second wheels of the steering axle reflect an intended trajectory as input by a driver when operating the steering wheel. In an autonomous or semi-autonomous vehicle, the input signal can instead be provided by an autonomous driving system.

In step F2, the actual angular position of the first and second wheels of the steering axle is determined. The desired angular position and the actual angular position of the wheels of the steering axle are then compared to establish a difference between the desired and actual angular positions (step F3). A failure of the vehicle steering system is typically determined if the established difference exceeds a predetermined threshold. Such a predetermined threshold may e.g. by an error margin of 5%, 10% or 20%.

In another alternative, the state of other components of the steering system can additionally be taken into account in the determination of a failure, such as the travel, angle and/or position of the steering rack. The current parameters relating to the different components is then compared to a range of possible parameter combinations according to the design of the system (including e.g. gear ratio of the rack and pinion, torsional stiffness of the components etc.). If the combination of current parameters falls outside of a permitted range, a failure of the steering system is determined.

In response the failure of the steering system determined in step S1, the method for emergency steering consists in a two-step approach: locking the wheels of the steering axle such that they are prevented from rotating (step S2) and applying a different torques to the respective wheels of the non-steering axle (Step S3). The torque difference creates a yaw moment, leading the vehicle to rotate about its yaw axis, thereby steering the vehicle to change trajectory. In principle, the same torque difference can be achieved by an infinite number of combinations of torques applied to the respective wheels. A simple torque split strategy can be used: torques of equal magnitude but opposite signs are applied to the first and second wheel of the non-steering axle. For example, if a torque difference of 500 Nm is needed, a drive torque of 250 Nm is applied on one wheel, and a brake torque of 250 Nm is applied on the other wheel. The drive torque is applied on the outside wheel whereas the brake torque is applied on the inside wheel. In other words, steering the vehicle to the right is achieved by applying a brake torque the right wheel and a drive torque to the left wheel of the non-steering axle. Steering to the left is conversely achieved by applying a drive torque to the right wheel and a brake torque to the left wheel of the non-steering axle. Alternatively, a first drive torque may be applied to the first wheel, and a second drive torque may be applied to the second wheel, wherein the first drive torque is larger than the second drive torque.

The step of locking the wheels of the steering axle (step S2) provides increased control of the emergency steering. Upon locking the wheels, the condition at the point of contact between the tires and the ground changes from rolling to sliding. This loss of grip of the tires results in a reduced ability of the wheels to steer the vehicle, irrespective of the actual angular position of the wheels. The risk of the wheels of the steering axle counteracting the torque difference applied to the wheels of the non-steering axle is therefore reduced. Depending of the angle of the wheels of the steering axle, the needed torque difference may be reduced.

If needed, the step of locking the wheels of the steering axle comprises disabling the anti-lock braking system (ABS) for those wheels.

The desired trajectory can be autonomously determined by the vehicle, e.g. based on input sensors like cameras or radar. For example, the vehicle may determine a trajectory to steer the vehicle to the side of the road where it may be safe to bring the vehicle to a halt.

In one implementation of the method for emergency steering, the torque difference to be applied to the wheels of the non-steering axle can be determined based on the angle of the steering wheel. In this scenario, the desired angular position of the wheels of the steering axle, as indicated by the angle of the steering wheel, is used to calculate a corresponding torque difference needed to be applied on the wheels of the non-steering axle to achieve the same steering.

The torque difference needed to steer the vehicle into the desired trajectory can be determined based on a simple control strategy. According to this strategy, a deviation between the desired trajectory and the current trajectory of the vehicle is determined, and the torque difference to be applied is continuously updated so as to minimize the deviation. A greater deviation results in more aggressive steering, i.e. a higher applied torque difference.

From a safety point of view, it may however be advantageous to combine the steps S1-S3 described above with automatic object detection, to avoid a potential collision with an object in the travel path of the vehicle. The optional steps D1 to D5 illustrate this principle.

Step D1 consists in detecting an object in the environment of the vehicle. This step can be initiated upon determining a failure of the vehicle steering system in step S1. It is also possible that object detection is implemented in the vehicle in connection with other features or safety systems of the vehicle outside the scope of this disclosure. In this case, an object may already be detected before a failure of the vehicle steering system is determined. The object detected in step D1 can be a stationary object or a moving object.

A distance between the object and the vehicle is then determined, as well as a relative bearing of the object in relation to the vehicle (step D2). The relative bearing should be understood to be the angle between the heading of the vehicle, i.e. the direction in which the vehicle is pointing, and a line drawn between the vehicle and the object. A current trajectory of the vehicle is determined in step D3. Based on the distance and relative bearing of the object and on the current trajectory of the vehicle, it is determined in step D4 whether the object is in a travel path of the vehicle. In the case of a moving object, this includes determining whether a collision will occur, based on a travel path of the object and the current trajectory of the vehicle. Step D5 then consists in determining the torques to apply to the respective wheels of the non-steering axle to avoid a collision between the vehicle and the object.

The steps D1 to D4 can be performed continuously and in parallel. In so doing, the determined torque difference to be applied can be continuously updated in response to the change in position of the object in relation to the vehicle. For example, the smaller the relative bearing angle, the more the vehicle needs to be steered to one side to avoid the object, and the higher the torque difference needs to be applied.

It should also be noted that it is not an object of the method to allow the vehicle to be driven indefinitely after a failure of the steering system. Rather, the method is intended to bring the vehicle to a safe stop as soon possible. For example, once a potential collision with the detected object has been avoided, the vehicle can safely be brought to a stop. One way to determine that a risk of collision with the object no longer exists is for example to establish that the angle between the bearing of the object and the heading of the vehicle is at 90° and that the distance between the object and the vehicle is greater than the track width of the vehicle. This could indicate that the object has successfully been avoided.

Alternatively, the method comprises detecting a traffic marker in an environment of said vehicle, and determining the first torque and second torque needed to steer said vehicle into said desired trajectory for avoiding crossing path with said traffic marker. The traffic marker may e.g. be a marker delimiting a lane of a road. As such, the method may serve to keep the vehicle in the traffic lane in which the vehicle is currently travelling.

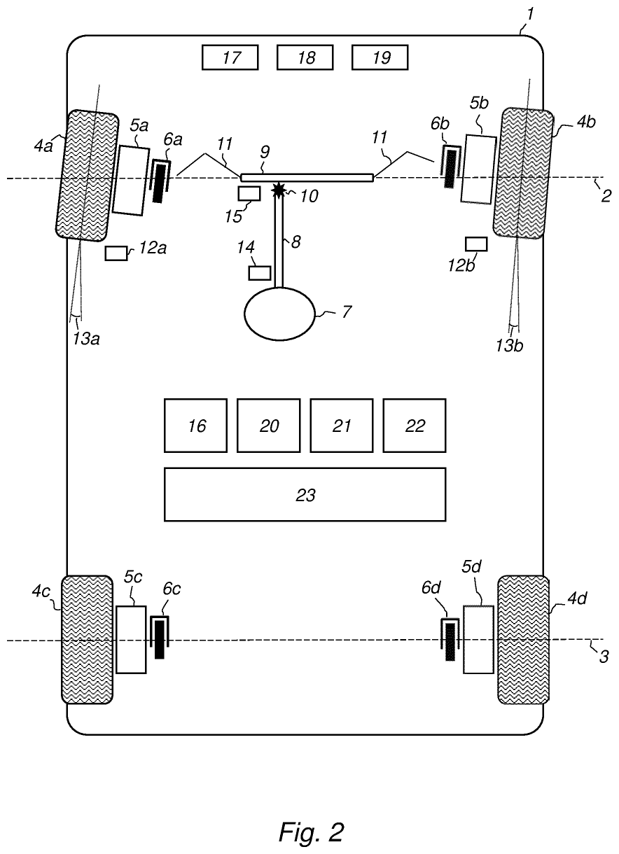

FIG. 2 schematically illustrates a vehicle 1 comprising an emergency steering system according to the present disclosure. The vehicle comprises a steering axle 2 and a non-steering axle 3. In the illustrated embodiment, the steering axle 2 is the front axle of the vehicle and the non-steering axle 3 is the rear axle of the vehicle. The steering axle thus comprises a front left wheel 4a and a front right wheel 4b, both of which are steerable by the vehicle steering system. The non-steering axle has a rear left wheel 4c and a rear right wheel 4d. Each wheel 4a-d is powered by a respective independent electric motor 5a-d. Each wheel 4a-d is also associated with a respective independently operable brake 6a-d.

Alternative arrangements are possible. In particular, it should be noted that although the vehicle 1 is here described to have four independently operable motors, the vehicle could have a single motor powering the front wheels, or no motor powering the front wheels. The rear wheels could similarly be powered by a single motor, with a differential system handling torque distribution between the wheels.

The vehicle steering system is schematically illustrated as comprising a steering wheel 7, a steering column 8, a rack 9 and pinion 10, and tie rods 11, which together forms a mechanical control mechanism of the steering axle. Wheel angle sensors 12a, 12b are configured to determine an angular position of each the respective front wheels 4a, 4b in relation to the steering axle. The respective angular positions can be determined by measuring the respective angles 13a, 13b between the longitudinal extension of the wheels 4a, 4b and the longitudinal extension of the vehicle 1, perpendicular to the axle 2. A steering wheel angle sensor 14 is configured to determine the angle of the steering wheel 7. A rack sensor 15 is configured to determine a travel, angle and/or position of the steering rack 9. The wheel angle sensors 12a and 12b, the steering wheel angle sensor 14, and the rack sensor 15 are in data communication with a steering system failure determining unit 16. In alternative embodiments, the steering control may be a steer by wire set-up where there are no mechanical connections between the steering wheel and the steering axle. Instead electronic control of the axle is achieved by a motorized control and based on input signals from the steering wheel.

The system illustrated in FIG. 2 comprises a radar 17, a lidar 18 and a camera 19. Depending on the implementation, the system could comprise any combination of the different types of sensor 17, 18, 19, including zero or multiple sensors of the same type. Each radar, lidar, and camera is in data communication with an object detection unit 20.

An inertial measurement unit 21 is configured to determine an orientation, including a heading, of the vehicle 1. The emergency steering system can further comprise a navigation system 22 using GPS.

The steering system failure determining unit 16, the object detection unit 20, the inertial measurement unit 21, and the navigation system 22 are in data communication with a control unit 23. The control unit 23 is also in data communication with each of the motors 5a-d and each of the brakes 6a-d, such that the control unit 23 is adapted to control the drive torque or brake torque applied to each respective wheel 4a-d.

Different architectures of the system are conceivable. A more centralized architecture, in which several electronic control units are combined, or a more de-centralized architecture, in which electronic control units are distributed, may be implemented. For example, functions herein described as performed by the steering failure determining unit 16 and the control unit 23 may be combined into a single electronic control unit. Conversely, the control unit 23 described in this disclosure may in practice be implemented as several control units, e.g. controlling a specific component or group of components. Additionally, the electronic control units and other components of the vehicles may be combined with and/or in communication with other systems and components of the vehicle outside the scope of this disclosure.

In use of the emergency steering system, the steering system failure determining unit 16 is configured to determine a failure of the vehicle steering system based on sensor data receive from the wheel angle sensors 12a, 12b, the steering wheel angle sensor 14, and optionally the rack sensor 15. Additional sensors relating to further components of the steering system may additionally be used in determining a failure of the steering system, as described above in connection with FIG. 1.

The steering system failure detection unit 16 communicates that a failure of the vehicle steering system has occurred to the control unit 23. The control unit 23 then controls the front brakes 6a, 6b and optionally the front motors 5a, 5b to apply a braking torque to the respective front wheels 4a, 4b to lock the wheels and prevent them from rotating. If a maximum braking torque is to be applied, the front brakes 6a, 6b and the front motors 5a, 5b act in conjunction, the motors 5a, 5b functioning as regenerative brakes. The front brakes 6a, 6b, and front motors 5a, 5b if applicable, thus function as locking members for the wheels of the steering axle 2. Other means of locking the wheels are conceivable for the skilled person.

The control unit 23 is configured to determine the torques to be applied on the respective rear wheels 4c, 4d in accordance with the method described above. Further, the control unit 23 controls the rear motors 5c, 5d and/or rear brakes 6c, 6d, to apply the determined torques. A drive torque is applied by a motor 5c or 5d, whereas a brake torque may be applied by a brake 6c or 6d, or by a brake in conjunction with a motor functioning as a regenerative brake. The rear motors 5c, 5d and rear brakes 6c, 6d can thus act as torque applying members, independently or in cooperation, depending of the torques needed.

The object detection unit 20 is configured to detect an object (not shown in FIG. 2) in the environment of the vehicle 1, based on data provided by the radar 17, lidar 18, and/or camera 19. The control unit 23 is configured to determine a desired trajectory for avoiding a collision with the object, and to determine the torques needed on the rear wheels 4c, 4d to steer the vehicle 1 into the desired trajectory.

In a specific implementation, the object detection unit is further configured to determine a distance and relative bearing of the object in relation to the vehicle 1. The control unit 23 can determine, based on data provided by the sensors 17, 18, 19 as well as the inertial measurement unit 21 and/or the navigation system 22, a current trajectory of the vehicle 1. The control unit 23 the determines if the object is in a travel path of the vehicle 1 and adjusts the desired trajectory, and thus the torques to be applied to the rear wheels 4c, 4d accordingly. This is described in further detail in connection to steps D1-D5 of FIG. 1 above.

The person skilled in the art realizes that the present invention by no means is limited to the embodiments described above. The features may be combined in different ways, and many modifications and variants are possible within the scope of the appended claims. In the claims, any reference signs placed in parenthesis shall not be construed as limiting the claim. The word “comprising” does not exclude the presence of other elements than those listed in the claim. The word “a” or “an” preceding an element does not exclude the presence of a plurality of such elements.

1. A method for emergency steering of a vehicle in response to a failure of a vehicle steering system, the method comprising the steps of:
determining, by a steering system failure determining unit, a failure of the vehicle steering system,
locking a first and a second wheel of a steering axle of said vehicle, such that said first and second wheels of said steering axle are prevented from rotating, and
applying a first drive torque to a first wheel of a non-steering axle of said vehicle and a second different torque to a second wheel of a non-steering axle of said vehicle by a torque applying member, thereby steering the vehicle into a desired trajectory.

2. The method according to claim 1, wherein the second different torque is a drive torque.

3. The method according to claim 1, wherein the method further comprises:
detecting an object in an environment of said vehicle, and
determining the first torque and second torque needed to steer said vehicle into said desired trajectory for avoiding a collision between said vehicle and said object.

4. The method according to claim 3, further comprising
determining a distance and a relative bearing of said object in relation to said vehicle,
determining a current trajectory of said vehicle, and
determining if said object is in a travel path of said vehicle based on said distance and relative bearing of said object and said current trajectory of said vehicle.

5. The method according to claim 1, wherein said step of determining a failure of the vehicle steering system further comprises:
receiving an input signal indicative of a desired angular position of said first and second wheels of said steering axle in relation to said steering axle,
determining an actual angular position of said first and second wheels of said steering axle in relation to said steering axle, and
establishing a difference between said desired angular position and said actual angular position of said first and second wheels of said steering axle in relation to said steering axle.

6. The method according to claim 1, wherein the step of locking the first and second wheel of the steering axle comprises disabling the anti-lock braking system (ABS) for said first and second wheel of the steering axle.

7. An emergency steering system of a vehicle for steering the vehicle in response to a failure of a vehicle steering system, comprising:
a steering system failure determining unit configured to determine a failure of the vehicle steering system,
a locking member configured to lock a first and second wheel of a steering axle of said vehicle, such that the first and second wheels of said steering axle are prevented from rotating, when a failure of the steering system has been determined, and
a torque applying member configured to apply a first drive torque to a first wheel and a second different torque to a second wheel of a non-steering axle of said vehicle, thereby steering the vehicle into a desired trajectory, wherein the torque applying member comprises a motor.

8. The system according to claim 7, further comprising:
an object detection unit configured to detect an object in an environment of said vehicle,
wherein the system is further configured to determine the first torque and second torque needed to steer said vehicle into said desired trajectory for avoiding a collision between said vehicle and said object.

9. The system according to claim 8, further configured to:
determine a distance and a relative bearing of said object in relation to said vehicle,
determine a current trajectory of said vehicle, and
determine if said object is in a travel path of said vehicle based on said distance and relative bearing of said object and said current trajectory of said vehicle.

10. The system according to claim 7, wherein the steering system failure determining unit is further configured to:
receive an input signal indicative of a desired angular position of said first and second wheels of said steering axle in relation to said steering axle,
determine an actual angular position of said first and second wheels of said steering axle in relation to said steering axle, and
establish a difference between said desired angular position and said actual angular position of said first and second wheels of said steering axle in relation to said steering axle.

11. The system according to claim 7, further comprising two torque applying members, wherein a first torque applying member is configured to apply a first torque to a first wheel of a non-steering axle of said vehicle and a second torque applying member is configured to apply a second different torque to a second wheel of a non-steering axle of said vehicle.

12. A vehicle comprising a system according to claim 7.

13. A computer program comprising program code means for performing the steps of claim 1, when said program is run in an embedded system in a vehicle.
